(19) United States
(12) Patent Application Publication
(10) Pub. No.: US 2026/0216915 A1
(43) Pub. Date: Jul. 30, 2026

(54) SYSTEMS AND METHODS OF ADDITIVE MANUFACTURING WITH MULTIPLE EXTRUDERS

(71) Applicant: BRIGHAM YOUNG UNIVERSITY, Provo, UT (US)

(72) Inventors: Taylor James Sorensen, Springville, UT (US); Dexter Rodriguez, Orem, UT (US)

(21) Appl. No.: 19/457,842

(22) Filed: Jan. 23, 2026

Related U.S. Application Data
(60) Provisional application No. 63/749,205, filed on Jan. 24, 2025.

(51) Int. Cl. B28B 1/00; B22F 10/22; B22F 10/85; B22F 12/55; B28B 17/00; B33Y 10/00; B33Y 30/00; B33Y 50/02

(52) U.S. Cl. CPC B28B 1/001; B22F 10/22; B22F 10/85; B22F 12/55; B28B 17/0081; B33Y 10/00; B33Y 30/00; B33Y 50/02

(57) ABSTRACT

Embodiments disclosed herein are systems and method of additive manufacturing with multiple extruders. An additive manufacturing system includes one or more material sources having one or more materials, one or more printing heads, a first extruder, a second extruder, and a controller operably coupled to the one or more printing heads, the first extruder, and the second extruder. The controller is configured to coordinate movement of the one or more printing heads, simultaneous movement of the first extruder and the second extruder, and extrusion of (1) material from the first extruder at one or more first locations and (2) material from the second extruder at one or more second locations contacting at least a portion of the first material within a predetermined amount of time before the material from the first extruder at the at least a portion of the one or more first locations solidifies.

### CROSS-REFERENCE TO RELATED APPLICATIONS

This application claims priority to U.S. Provisional Ser. No. 63/749,205 filed on Jan. 24, 2025 the disclosure of which is incorporated herein, in its entirety, by this reference.

### BACKGROUND

Additive manufacturing systems may print objects in three dimensions, but also may be limited to a single extruder that is a significant limitation on conventional systems. For example, a single extruder may significantly limit the printing speed of an additive manufacturing system. Additionally, this use of a single extruder system inherently means that only one material can be utilized in the automated printing process at a time.

### SUMMARY

Embodiments disclosed herein include systems and methods of additive manufacturing with multiple extruders. In an embodiment, an additive manufacturing system includes one or more material sources having one or more materials, one or more printing heads, a first extruder, a second extruder, and a controller. The first extruder is secured to at least one of the one or more printing heads and operably coupled to a material source of the one or more material sources. The first extruder is configured to selectively deposit a material of the one or more materials from the one or more material sources. The second extruder is secured to at least one of the one or more printing heads and operably coupled to a material source of the one or more material sources. The second extruder is configured to selectively deposit a material of the one or more materials from the one or more material sources. The controller is operably coupled to the one or more printing heads, the first extruder, and the second extruder. The controller is configured to coordinate movement and independent translation of the one or more printing heads, simultaneous movement of the first extruder and the second extruder, and extrusion or deposition of (1) material from the first extruder at one or more first locations and (2) material from the second extruder at one or more second locations contacting the first material proximate to at least a portion of the one or more first locations within a predetermined amount of time before the material from the first extruder at the at least a portion of the one or more first locations solidifies.

In an embodiment, an additive manufacturing system includes one or more material sources having one or more materials, one or more printing heads, a first extruder, a second extruder, and a controller. The first extruder is secured to at least one of the one or more printing heads and operably coupled to a material source of the one or more material sources. The first extruder is configured to selectively deposit a material of the one or more materials from the one or more material sources. The second extruder is secured to at least one of the one or more printing heads and operably coupled to a material source of the one or more material sources. The second extruder is configured to selectively deposit a material of the one or more materials from the one or more material sources. The controller is operably coupled to the one or more printing heads, the first extruder, and the second extruder. The controller is configured to coordinate movement and independent translation of the one or more printing heads, simultaneous movement of the first extruder and the second extruder, and extrusion of material of the one or more materials from the first extruder at one or more first locations on a first plane. The controller also is configured to coordinate extrusion of material of the one or more materials from the second extruder at one or more second locations on the first plane within a predetermined amount of time from the extrusion of the material from the first extruder on the first plane. The controller also is configured to coordinate extrusion of material of the one or more materials from the first extruder at one or more additional first locations on a second plane and at least partially overlapping the one or more first locations before at least some of the material from the first extruder on the first plane has solidified. The controller also is configured to coordinate extrusion or deposition of material of the one or more materials from the second extruder at one or more additional second locations on the second plane and at least partially overlapping the one or more second locations before at least some of the material from the second extruder on the first plane has solidified.

In an embodiment, a method of manufacturing includes, with a controller, coordinating movement of one or more printing heads of an additive manufacturing system. The method also includes, with the controller, coordinating simultaneous movement and independent translation of a first extruder secured to at least one of the one or more printing heads and a second extruder secured to at least one of the one or more printing heads. The method also includes, with the controller, coordinating extrusion of material from the first extruder at one or more first locations on a first plane. The method also includes, with the controller, coordinating extrusion or deposition of material from the second extruder at one or more second locations on the first plane contacting the first material proximate to at least a portion of the one or more first locations within a predetermined amount of time of the extrusion of the material from the first extruder before the material from the first extruder at the at least a portion of the one or more first locations solidifies.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of an additive manufacturing system, according to an embodiment.

FIG. 2A is a top isometric view of a printing head of an additive manufacturing system, according to an embodiment.

FIG. 2B is a bottom view of the printing head of FIG. 2A.

FIG. 2C is an isometric cutaway view of the printing head of FIG. 2A.

FIG. 3A is a top view of a wall printed with an additive manufacturing system, according to an embodiment.

FIG. 3B is a cross-section side view of the wall of FIG. 3A from line 3B-3B of FIG. 3A, according to an embodiment.

FIG. 4 is a flow diagram of a method of manufacturing a wall, according to an embodiment.

### DETAILED DESCRIPTION

Embodiments disclosed herein are systems and methods of additive manufacture with multiple extruders. Conventional additive manufacturing systems may print objects in three dimensions, but also may be limited to a single extruder. This use of a single extruder system means a significant limitation on conventional systems may include the printing speed. Additionally, this use of a single extruder system inherently means that only one material can be utilized in the automated printing process at a time. Embodiments of additive manufacturing systems disclosed herein having multiple extruders have the benefit of allowing faster printing speed and/or the possibility of composite printing (e.g. substantially simultaneously) with multiple materials, resulting in improved versatility of additive manufacturing and an improved process itself.

According to various embodiments, the multiple extruders may all be secured to a single printing head or systems and methods may utilize multiple printing heads each having one or more extruders secured thereto and printing in coordination with one another. Systems and methods may include a controller configured to coordinate substantially simultaneous or asynchronous extrusion of material from the multiple extruders to print or otherwise form a three-dimensional (3D) object. At least one, some, or all embodiments disclosed herein increase additive manufacturing printing speed and reduce printing time by using substantially simultaneous printing with multiple extruders. In some embodiments, the systems and methods disclosed herein are configured to facilitate printing objects with multiple different materials, thereby allowing for the printing of composite elements. A controller having one or more processors may be utilized in conjunction with the multiple extruders in order to form an object (e.g., wall or other structure) with the multiple extruders using one or more (e.g., multiple) materials.

As shall be described in greater detail below, many embodiments disclosed herein include multiple extruders working substantially simultaneously or asynchronously to produce better printing results in at least one of (e.g., both) speed and material versatility. Extruders may be operated as multiple independent units (e.g., multiple printing heads each having one or more extruders secured thereto) or installed within a single printing head (e.g., a single printing head having multiple extruders secured thereto). Systems and methods disclosed herein may include a controller configured to coordinate operation of the multiple extruders in a coordinated manner (e.g., substantially simultaneously, within a predetermined time period, and/or within a predetermine range of one another).

In some non-limiting embodiments, the systems and methods disclosed herein may be used to 3D print a concrete object (e.g., wall or structure) through additive manufacturing for the purpose of printing composite systems. In some non-limiting embodiments, the systems and methods disclosed herein may be used to 3D print a composite material including one or more plastics. In some non-limiting embodiments, the systems and methods disclosed herein may be used to 3D print other material types, such as fluid materials, gel materials, solid filament materials, foams, or combinations thereof. Furthermore, the incorporation of multiple extruders configured to deposit different materials in a single object allows embodiments disclosed herein to 3D print or otherwise form a structure including multiple materials including two or more of concrete, metal, plastic, foam, insulation, solid filament material, drywall, fluid, gel within a predetermined amount of time (e.g., substantially simultaneously) and/or within a predetermined distance of one another.

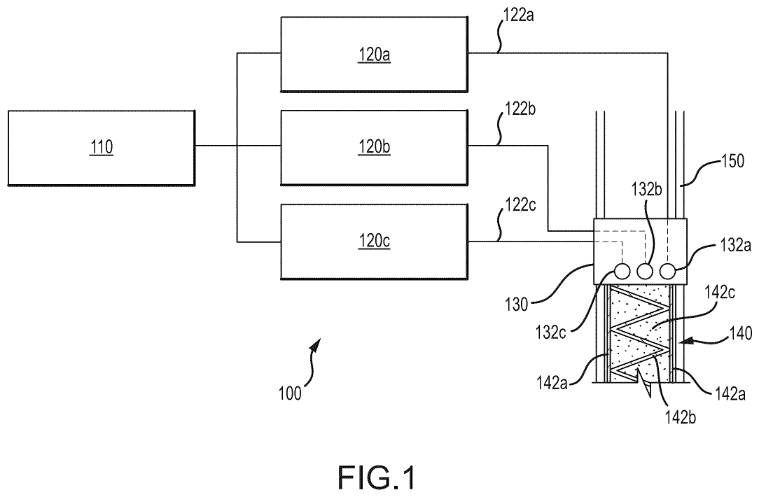

Turning now to the drawings, FIG. 1 is a block diagram of an additive manufacturing system 100, according to an embodiment. The additive manufacturing system 100 may include a controller 110 operably coupled to at least one (e.g. both) of multiple material sources 120a-c and a printing head 130. The multiple material sources 120a-c may include containers configured to hold or store a material. In some embodiments, the multiple material sources 120a-c all include the same material. In some embodiments, at least one material source 120a includes a material different than the material of the other material sources 120b and/or 120c. While the embodiment shown in FIG. 1 includes three material sources 120a-c, other embodiments may include one, two, four, five, etc. material sources operably coupled to the controller 110 and the printing head 130.

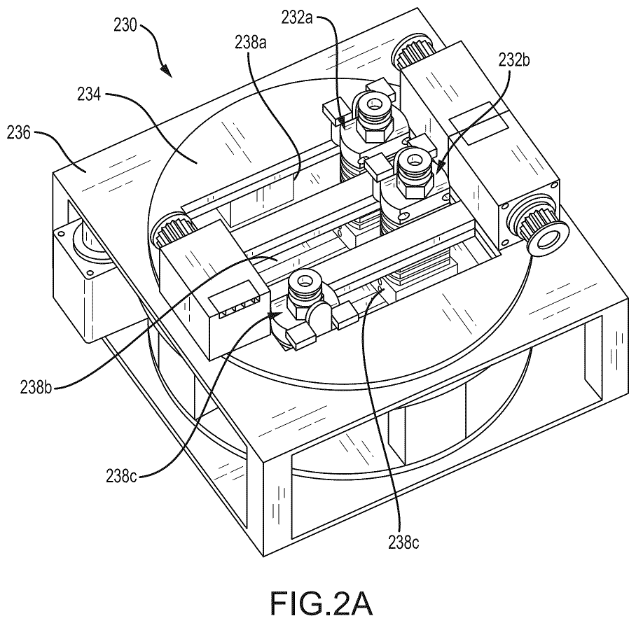

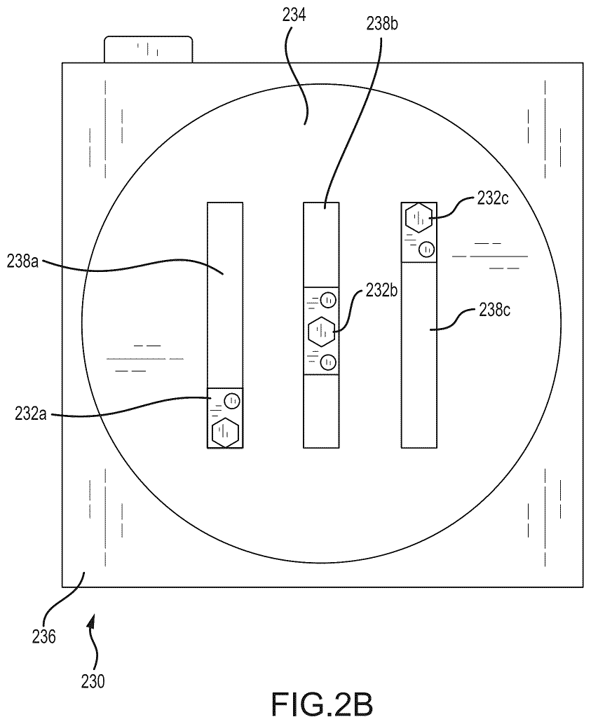

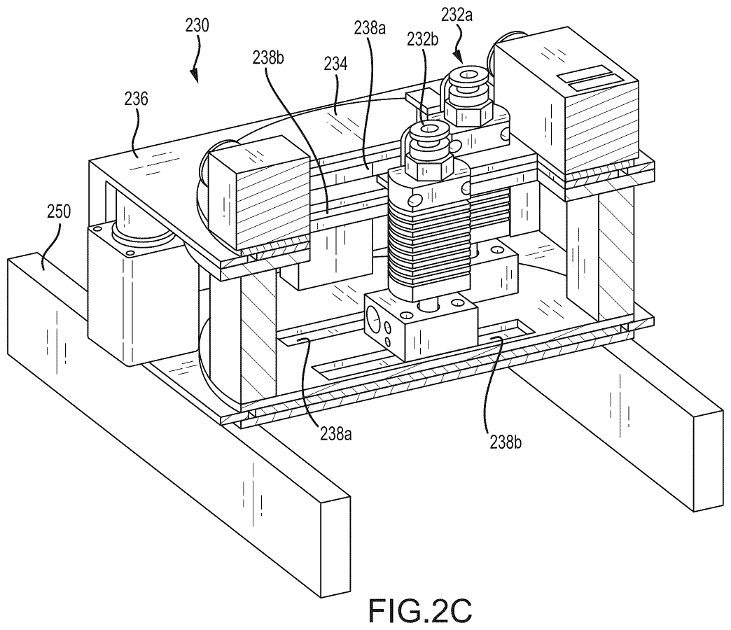

The printing head 130 includes multiple extruders 132a-c operably and/or fluidly coupled to at least one of the multiple material sources 120a-c and operably coupled to the controller 110, according to an embodiment. For example, the system 100 may include multiple lines 122a-c or conduits connecting the multiple material sources 120a-c to corresponding extruders 132a-c. The extruders 132 and printing head 130 are described in greater detail below in relation to FIGS. 2A-2C. In short, though, upon instruction and coordination from the controller 110, the extruders 132 are configured to deposit (e.g., extrude) material from the material source 120 at a predetermined and/or selected time and a predetermined and/or selected position. As used herein, deposit

In the embodiment shown in FIG. 1, the printing head 130 includes three extruders 132a-c each fluidly and operably coupled to a corresponding different material source of the multiple material sources 132a-c. More particularly a first extruder 132 a may be fluidly and operably coupled to a first material source 120a, a second extruder 132b may be fluidly and operably coupled to a second material source 120b, and a third extruder 132c may be fluidly and operably coupled to a third material source 120c. While the embodiment shown in FIG. 1 includes the three material sources 120a-c and the three extruders 132a-c on the printing head 130, other embodiments may include one or more material sources 120 and multiple extruders 132 (e.g., two, three, four, five, etc.) each coupled to at least one of the one or more material sources 120. More particularly, in some embodiments, the printing head 130 may include at least two extruders 132 operably and fluidly coupled to a single material source 120 having a single material. In some embodiments, the printing head 130 may include at least two extruders 132 each operably and fluidly coupled to two different material sources 120 each having the same material as one another. In some embodiments, the printing head 130 may include at least two extruders 132 each operably and fluidly coupled to at least two extruders 132 each having a different material from one another. In some embodiments, the additive manufacturing system 100 may include a single printing head 130 having two or more extruders of the multiple extruders 132a-c secured thereto. In some embodiments, the additive manufacturing system 100 may include a first printing head 130 having the first extruder 132a secured thereto and a second printing head 130 having the second extruder 132b secured thereto.

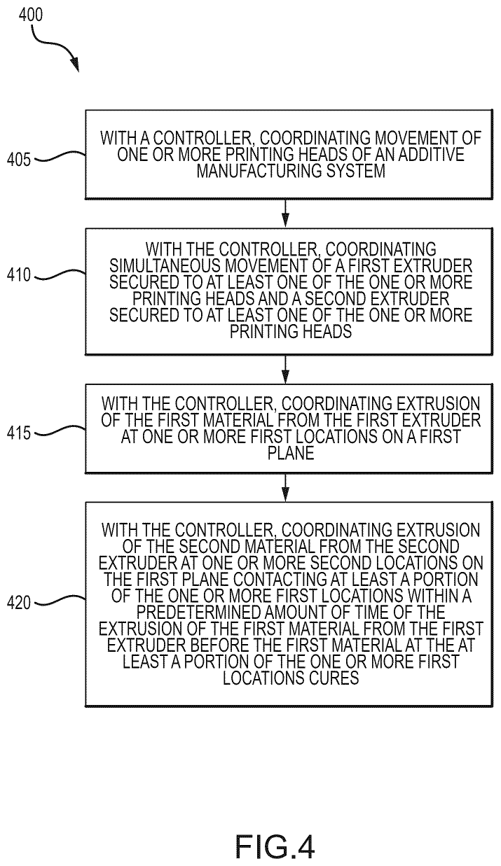

The controller 110 may be configured to carry out or coordinate any of the methods or acts of the system disclosed herein. The controller 110 may be configured to implement any of the example methods disclosed herein, such as the method 400 (shown in FIG. 4). The controller 110 includes at least one computing device configured to perform or coordinate one or more of the acts described herein, such as acts of the method 400. The at least one computing device can include one or more servers, one or more computers (e.g., desk-top computer, lap-top computer), or one or more mobile computing devices (e.g., smartphone, tablet, etc.). The computing device can comprise at least one processor, memory, a storage device, an input/output (“I/O”) device/interface, and a communication interface. In some examples, the controller 110 or the computing device can include fewer components than those described herein. In some examples, the at least one computing device may include a plurality of computing devices, such as a server farm, computational network, or cluster of computing devices.

In some examples, the processor(s) of the controller 110 includes hardware for executing instructions (e.g., instructions for carrying out one or more portions of any of the methods disclosed herein), such as those making up a computer program. For example, to execute instructions, the processor(s) may retrieve (or fetch) the instructions from an internal register, an internal cache, the memory, or a storage device and decode and execute them. In particular examples, processor(s) may include one or more internal caches for data. As an example, the processor(s) may include one or more instruction caches, one or more data caches, and one or more translation lookaside buffers (TLBs). Instructions in the instruction caches may be copies of instructions in memory or storage device. In some examples, the processor may be configured (e.g., include programming stored thereon or executed thereby) to carry out or coordinate one or more portions of any of the example methods disclosed herein.

In some examples, the processor of the controller 110 is configured to perform or coordinate any of the acts disclosed herein, such as in the method 400, or cause one or more portions of the computing device or controller to perform at least one of the acts disclosed herein. Such configuration can include one or more operational programs (e.g., computer program products) that are executable by the at least one processor of the controller 110.

The at least one computing device (e.g., a server) of the controller 110 may include at least one memory storage medium (e.g., memory and/or storage device). The computing device of the controller 110 may include memory, which is operably coupled to the processor(s). The memory of the controller 110 may be used for storing data, metadata, and programs for execution by the processor(s). The memory may include one or more of volatile and non-volatile memories, such as Random Access Memory (RAM), Read Only Memory (ROM), a solid state disk (SSD), Flash, Phase Change Memory (PCM), or other types of data storage. The memory may be internal or distributed memory.

The computing device of the controller 110 may include the storage device having storage for storing data or instructions. The storage device may be operably coupled to the at least one processor. In some examples of the controller 110, the storage device may comprise a non-transitory memory storage medium, such as any of those described above. The storage device (e.g., non-transitory storage medium) of the controller 110 may include a hard disk drive (HDD), a floppy disk drive, flash memory, an optical disc, a magneto-optical disc, magnetic tape, or a Universal Serial Bus (USB) drive or a combination of two or more of these. The storage device of the controller 110 may include removable or non-removable (or fixed) media. The storage device may be internal or external to the computing device of the controller 110. In some examples, storage device may include non-volatile, solid-state memory. In some examples, storage device may include read-only memory (ROM). Where appropriate, this ROM may be masking programmed ROM, programmable ROM (PROM), erasable PROM (EPROM), electrically erasable PROM (EEPROM), electrically alterable ROM (EAROM), or flash memory or a combination of two or more of these. In some examples of the controller 110, one or more portions of the memory and/or storage device (e.g., memory storage medium(s)) may store one or more databases thereon.

In some examples of the controller 110, the at least one processor may be configured to access (e.g., via a bus) the memory storage medium(s) such as one or more of the memory or the storage device. For example, the at least one processor may receive and store the data (e.g., look-up tables) as a plurality of data points in the memory storage medium(s).

The computing device of the controller 110 also may include one or more I/O devices/interfaces, which are provided to allow a user to provide input to, receive output from, and otherwise transfer data to and from the computing device. These I/O devices/interfaces may include a mouse, keypad or a keyboard, a touch screen, camera, optical scanner, network interface, web-based access, modem, a port, other known I/O devices or a combination of such I/O devices/interfaces. The touch screen may be activated with a stylus or a finger.

The I/O devices/interfaces of the controller 110 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, the I/O devices/interfaces are configured to provide graphical data to a display for presentation to a user. The graphical data may be representative of one or more graphical user interfaces and/or any other graphical content as may serve a particular implementation.

The computing device of the controller 110 can further include a communication interface. The communication interface can include hardware, software, or both. The communication interface can provide one or more interfaces for communication (such as, for example, packet-based communication) between the computing device and one or more additional computing devices or one or more networks. For example, the communication interface may include a network interface controller (NIC) or network adapter for communicating with an Ethernet or other wire-based network or a wireless NIC (WNIC) or wireless adapter for communicating with a wireless network, such as a WI-FI. Any suitable network and any suitable communication interface may be used. For example, the computing device of the controller 110 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of the controller 110 or computing device of the controller 110 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. The computing device of the controller 110 may include any suitable communication interface for any of these networks, where appropriate.

The computing device of the controller 110 may include a bus. The bus can include hardware, software, or both that couples components of the computing device to each other. For example, the bus may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Returning to FIG. 1, the controller 110 is operably coupled to the printing head 130, the first extruder 132a, the second extruder 132b, and the third extruder 132c. The controller 110 may be configured to coordinate movement of the printing head 130 on a track 150. For example, the system 100 may include at least one of one or more motors or one or more actuators configured to selectively move the printing head 130 in response to instructions or commands from the controller 110. The controller 110 also may be configured to coordinate movement of at least the first extruder 132a and the second extruder 132b. In embodiments having more than two extruders (e.g., at least a third extruder 132c), the controller 110 is configured to coordinate movement of all the multiple extruders 132. The system 100 and/or printing head 130 may include at least one of one or more motors or one or more actuators configured to selectively move the multiple extruders 132a-c in response to instructions or commands from the controller 110. In many embodiments, the controller 110 is configured to coordinate substantial simultaneous movement of at least two extruders of the multiple extruders 132a-c.

The controller 110 also is configured to coordinate extrusion of material from the multiple extruders of the printing head 130. For example, the controller 110 may be configured to coordinate extrusion of (1) material (e.g., the first material 142a from the first material source 120a) from the first extruder 132a at one or more first locations, and (2) material (e.g., the second material 142b from the second material source 120b) from the second extruder 132b at one or more second locations contacting the first material 142a proximate to (e.g., contact the first material at) at least a portion of the one or more first locations. In some embodiments controller 110 is configured to coordinate movement of the third extruder 132c and extrusion of material (e.g., the third material 142c from the third material source 120c) from the third extruder 132c at one or more third locations contacting the first material 142a proximate to at least a portion of at least one of the one or more first locations or the second material 142b proximate to at least a portion of the one or more second locations. Coordinating movement of the multiple extruders 132a-c and coordinating extrusion of material from the multiple extruders 132a-c in locations where at least some of the material(s) from the different extruders 132a-c contact each other allows for at least some of material(s) from the different extruders 132a-c to at least partially bond with one another on a non-horizontal orientation (e.g., substantially vertical bonding or substantially angled bonding).

In many embodiments, the controller 110 is configured to coordinate extrusion of material from the first extruder 132a and material from the second extruder 132b at substantially the same time. The controller 110 also may be configured to coordinate extrusion of material 142a from the first extruder 132a at one or more first locations and material 142b from the second extruder 132b at one or more second locations contacting the first material proximate to at least a portion of the one or more first locations within a predetermined amount of time before the material from the first extruder at the at least a portion of the one or more first locations completely solidifies (e.g., completely cures). For example, the controller 110 may be configured to coordinate extrusion of a first material 142a from the first extruder 132a and extrusion of a second material 142b from the second extruder 132b at one or more locations contacting at least a portion of the first material within a predetermined amount of time of less than about an hour, less than about 45 minutes, less than about 30 minutes, less than about 15 minutes, less than about 10 minutes, less than about 5 minutes, less than about 3 minutes, less than about 2 minutes, less than about 1 minutes, less than about 45 seconds, less than about 30 seconds, less than about 15 second, less than about 10 seconds, less than about 5 seconds, less than about 3 seconds, less than about 2 seconds, or less than about 1 second before the first material from the first extruder 132 a contacting the second material completely solidifies. In some embodiments, the predetermined amount of time may be more than an hour.

Solidification of the material(s) may occur through one or more material specific mechanisms, including but not limited to curing, cooling, polymerization, hydration, sintering, melting and resolidification, and other transitions from a flowable or extrudable state to a structurally stable state. Such solidification may occur due to ambient conditions or through applications of one or more solidification sources, including thermal, optical, electrical, chemical, or mechanical sources. As used herein, solidification refers to an initial transition of a deposited material from a flowable or extrudable state to a shape retaining state. In some embodiments, including cementitious materials, solidification may be followed by curing or other processes that result in continued strength gain or property development over time.

Similarly, the printing head 130 may simultaneously move at least two extruders of the multiple extruders 132a-c. The printing head 130 may include at least one of one or more motors or one or more actuators configured to selectively move the multiple extruders 132a-c in response to instructions or commands from the controller 110. In many embodiments, the printing head 130 is configured to allow for extrusion of material from the first extruder 132a and material from the second extruder 132b at substantially the same time. The printing head 130 also may be configured to allow for extrusion of material 142a from the first extruder 132a at one or more first locations and material 142b from the second extruder 132b at one or more second locations contacting the first material 142a proximate to at least a portion of the one or more first locations within the predetermined amount of time before the material from the first extruder at the at least a portion of the one or more first locations solidifies.

In many embodiments, the controller 110 is configured to coordinate extrusion of (1) material (e.g., the first material 142a from the first material source 120a) from the first extruder 132a at one or more first locations, and (2) material (e.g., the second material 142b from the second material source 120b) from the second extruder 132b at one or more second locations within a predetermined area and within a predetermined time. The predetermined time may include any of the times provided above. For example, the controller 110 may be configured to coordinate extrusion of (1) material (e.g., the first material 142a from the first material source 120a) from the first extruder 132a at one or more first locations, and (2) material (e.g., the second material 142b from the second material source 120b) from the second extruder 132b at one or more second locations within the predetermined time and within about 25 feet, within about 20 feet, within about 15 feet, within about 10 feet, within about 5 feet, within about 3 feet, within about 2 feet, within about 1 foot, within about 9 inches, within about 6 inches, within about 5 inches, within about 4 inches, within about 3 inches, within about 2 inches, within about an inch, and/or at least partially contacting the first material at the one or more first locations. Similarly, in many embodiments, the printing head 130 is configured to move the extruders 132a-c to allow extrusion of (1) material (e.g., the first material 142a from the first material source 120a) from the first extruder 132a at one or more first locations, and (2) material (e.g., the second material 142b from the second material source 120b) from the second extruder 132b at one or more second locations within the predetermined area and within the predetermined time.

Turning ahead in the drawings, FIG. 2A is a top isometric view of a printing head 230 of an additive manufacturing system, FIG. 2B is a bottom view of the printing head 230, and FIG. 2C is an isometric cutaway view of the printing head 230, according to an embodiment. The printing head 230 may be an example of the printing head 130 of the additive manufacturing system 100. In the illustrated embodiment, the printing head 230 includes three extruders 232a-c installed on the single printing head 230. The extruders 232a-c of the printing head 230 may be examples of the extruders 132 a-c of the printing head 130. In such an embodiment, the extruders 232a-c may be configured to translate independently within a plane while remaining coupled to collective movement of the printing head 230, thereby facilitating simultaneous and coordinated printing The extruders 232a-c may include a nozzle configured to deposit the material from the extruder. As used herein, an “extruder” may include any deposition mechanism configured to dispense, place, or deposit material, including molten, flowable, particulate, filament, or wire fed materials, or combinations thereof.

The printing head includes a chassis 236 and a cylinder 234 (or one or more plates) rotatably secured to the chassis 236. The printing head 230 may include at least one of one or more motors or one or more actuators configured to selectively rotate the cylinder 234 relative to the chassis 236 in response to instructions or commands from the controller 110. The cylinder 234 may include a multiple slots 238a-c configured and positioned to allow for adjacent translation of a corresponding extruder 232a-c. The printing head 230 may include at least one of one or more motors or one or more actuators configured to selectively move the extruders 232a-c in the slots 238a-c in response to instructions or commands from the controller 110. The printing head 230 may be configured to generally move or travel with the slots 238a-c aligned perpendicular to the line of motion. For example, the system may include one or more tracks 250 on which the printing head 230 is movable. The longitudinal translation, then, may be facilitated by movement of the printing head 230 itself, with the lateral capability of each extruder 232a-c providing access for each extruder 232a-c to print in any area within the printing path. In some embodiments, the printing head 230 may be secured to any of a number of different motion systems (e.g., gantry frame, cantilever arm, and so on). Accordingly, the printing head 230 may be configured, for example, to move in a direction perpendicular or angled relative to the slots 238a-c with one or more tracks 250 and/or other motion systems or configurations. Material (e.g., filament) for the extruders 232a-c may be supplied through the top of the extruders 232a-c. The extruders 232a-c and the printing head 230 may move by way of at least one of one or more motors, one or more gears, or one or more belts.

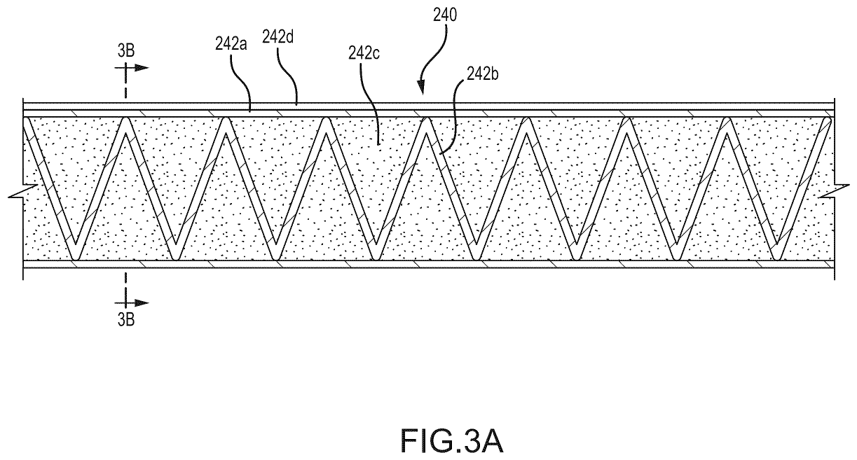

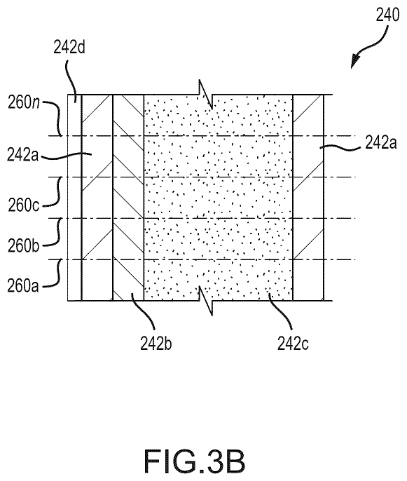

Turning ahead in the drawings, FIG. 3A is a top view of a wall 240 printed with the additive manufacturing system 100 and FIG. 3B is a cross-section side view of the wall 240 of FIG. 3A from line 3B-3B of FIG. 3A, according to an embodiment. While the wall 240 is shown in FIGS. 3A-3B, the wall 240 is merely an example of a structure that may be printed or formed embodiments of the additive manufacturing system 100 disclosed herein. The material deposited from the extruders 132a-c may be deposited (e.g., extruded) in patterns or geometrical configurations to provide structural support to the wall 240. For example, the wall 240 may include two outer layers of the first material 242a, a layer of the second material 242b extending back and forth (e.g., zig-zagging) between the two outer layers of the first material 242a, and third material 242c filling in the area between the second material 242b and the first material 242a.

With specific reference to FIG. 3B, in many embodiments, the controller 110 may be configured to deposit (e.g., extrude) material(s) from multiple extruders 132a-c on multiple planes 260a-n on top of one another within a predetermined amount of time (e.g., any of the predetermined times provided above). While in some instances, each plane 260a-n is substantially horizontal and/or substantially planar, the planes 260a-n as used herein may include a layer or printing level that is not substantially horizontal or substantially planar. For example, the controller 110 may configured to deposit (e.g., extrude) material(s) on multiple planes 260a-n as layers on top of previous layers within a predetermined amount of time before the adjacent lower layer as completely solidified (e.g. completely cured). In a particular embodiment, the controller 110 is configured to coordinate movement of one or more printing heads 130, substantially simultaneous movement of the first extruder 132a and the second extruder 132b, extrusion of material 242a from the first extruder 132a at one or more first locations on a first plane 260a, extrusion of material 242b from the second extruder 132b at one or more second locations on the first plane 260a within a predetermined amount of time from the extrusion of the material from the first extruder 132a on the first plane 260a, extrusion of material 242a from the first extruder 132a at one or more additional first locations on a second plane 260b and at least partially overlapping the one or more first locations on the first plane 260a before at least some of the material on the first plane 260a has solidified, and extrusion of material 242b from the second extruder 232b at one or more additional second locations on the second plane 260 and at least partially overlapping the material from the second extruder 232b at one or more second locations on the first plane 260a before at least some of the material from the second extruder 232b on the first plane 260a has solidified.

With reference to FIG. 1 and FIGS. 3A-3B, the additive manufacturing system 100 may be configured to deposit (e.g., extrude) multiple different materials from the multiple extruders 130a-c. For example, the additive manufacturing system 100 may include the first material source 120a having a first material and the second material source 120b having a second material different from the first material. In some embodiments, the additive manufacturing system 100 may include the third material source 120c having a third material different from at least one (e.g. both) of the first material or the second material. Extruding the different materials from the extruders 132a-c may allow the materials to bond together at locations where the materials are contacting one another as the materials cure.

In the non-limiting example shown in FIGS. 3A-3B, the first material 242a may be deposited (e.g., extruded) from at least the first extruder 132a on the first plane 260a at two locations spaced from one another. While the first material 242a is being deposited (e.g., extruded), or within a predetermined time of the first material being deposited, from at least the first extruder 132a on the first plane at the two locations, the second material 242b may be deposited from the second extruder 132b on the first plane 260a to contact at least some of the first material 242a on the first plane 260a before the first material 242a has completely solidified. In the example shown in FIG. 3A-3B, the second material 242b is deposited from the second extruder 132b back and forth in the space between the two locations of the first material 242a is deposited (e.g., extruded) by the first extruder 132a. In some embodiments, at least one of the two locations of the first material 242a is deposited (e.g., extruded) on the first plane 260a after the second material 242b is deposited on the first plane 260. The second material 242a may be deposited at an angle (e.g., perpendicular angle non-perpendicular angle) relative to the first material 242a.

In some embodiments, the third material 242c may be deposited by the third extruder 132c on the first plane 260a before or after at least one (e.g. both) of the first material 242a or the second material 242b has completely solidified. The third material 242c may be deposited in locations contacting at least one (e.g., both) of the first material 242a and the second material 242c. For example, the third material 242c may substantially fill the area on the first plane 260a between the two locations of the first material 242a not occupied by the second material 242b. In other words, the third material 242c may substantially fill one or more areas on the first plane 260a defined by both the first material 242a and the second material 242b. The process may be repeated on each plane 260b-n.

By way of a non-limiting example, the first material 242a may include a concrete material, the second material 242b may include a reinforcement material (e.g., a fiber-reinforced polymer material or metal material), and the third material 242c may include an insulation material (e.g., foam or filament). These materials 242a-c when deposited as disclosed herein may print a concrete sandwich-like structure, for example, having composite sandwich-like connectors. The controller 110 may be configured to coordinate extrusion of (1) the concrete material 242a from the first extruder 132a at a plurality of first locations, (2) the reinforcement material 242b from the second extruder 132b at the one or more second locations between portions of the plurality of first locations of the concrete material 242a and contacting the concrete material 242a proximate to at least some of the portions of the plurality of first locations of the concrete material 242a within the predetermined amount of time, and (3) the insulation material from the third extruder 132c at one or more third locations between the portions of the plurality of first locations of the concrete material 242a and contacting one or more of the concrete material 242a proximate to at least some of the portions of the plurality of first locations of the concrete material 242a or the reinforcement material 242 at one or more second locations of the fiber-reinforced polymer material 242b within the predetermined amount of time.

In some embodiments, at least one of the materials deposited by the multiple extruders 132a-c may include a metal material. For example, the system 100 may be configured to deposit a metal material to form reinforcement elements, conductive elements, or structural components, including in combination with other materials such as concrete, polymer material, or foam materials. In some embodiments, the printing head 130 and one or more extruders 132a-c may be configured to perform wire arc directed energy deposition (wire arc DED) to deposit a metal material, such as steel or aluminum, using a gas shielded arc welding process, including cold metal transfer or other arc welding processes. In such embodiments, the extruder configured for metal deposition may include or be operably coupled to a metal feed mechanism (e.g., a wire feeder), an energy source (e.g., a welding power supply), and a deposition head (e.g., a welding torch), and may optionally include shielding gas delivery. Such components and configurations may be integrated with the printing head 130 in a variety of architectures. The controller 110 may be configured to coordinate operation of the extruder configured for metal deposition, including control of one or more of wire feed rate, electrical power parameters, travel speed, and deposition timing, in coordination with deposition of other materials. In multi-material embodiments that include metal deposition, the controller 110 may further be configured to coordinate deposition order, spatial arrangement, and timing between deposition of the metal material and deposition of one or more other materials to accommodate material specific thermal effects and solidification characteristics. For example, the controller 110 may be configured to deposit (e.g., extrude) concrete material from the first extruder 132a and steel material from the second extruder 132b within any of the times provided above, such that the steel material is deposited at one or more locations and concrete material is subsequently deposited to substantially surround (e.g., envelop) an outer periphery of the deposited steel material.

Accordingly, in some embodiments, the second material 242b shown in FIGS. 3A-3B may include a metal material. While the second material is shown in a continuous zig-zag configuration in FIG. 3A, in other embodiments, the metal material may be deposited in other configurations or pattern, such as intermittent dots or dashes that, when layered upon one another on the multiple planes 260a-n form an elongated support structure (e.g., a metal bar). In these an other embodiments, at least one of the concrete material 242a or the insulation material 242c may at least partially (e.g., entirely) surround an outer periphery of the metal material deposited as the second material 242b.

In some embodiments, the system 100 also may include a fourth material source with a drywall material or other finishing material for a wall. The system 100 also may include a fourth extruder secured to at least one of the one or more printing heads 130 and operably coupled to the fourth material source. the fourth extruder configured to selectively deposit (e.g., extrude) the drywall material 242d. The controller 110 may be configured to coordinate extrusion of the drywall material 242d at one or more fourth locations adjacent to the one or more first locations with at least some of the concrete material 242a deposited (e.g., extruded) from the first extruder 132a between the drywall material 242d deposited (e.g., extruded) by the fourth extruder and at least some of at least one of the insulation material 242c or the reinforcement material 242d.

FIG. 4 is a flow diagram of a method 400 of manufacturing a wall, according to an embodiment. The method 400 may include any embodiments of the additive manufacturing systems 100 and controllers 110 disclosed herein. In an embodiment, the method 400 includes, with the controller, coordinating 405 movement of one or more printing heads of an additive manufacturing system. The method 400 also may include, with the controller, coordinating 410 simultaneous movement of a first extruder secured to at least one of the one or more printing heads and a second extruder secured to at least one of the one or more printing heads. The method 400 also may include, with the controller, coordinating 415 extrusion of material from the first extruder at one or more first locations on a first plane. The method also may include, with the controller, coordinating 420 extrusion of material from the second extruder at one or more second locations on the first plane contacting the first material proximate to at least a portion of the one or more first locations within a predetermined amount of time of the extrusion of the material from the first extruder before the material from the first extruder at the at least a portion of the one or more first locations solidifies.

In some embodiments of the method 400, the controller coordinates substantially simultaneous extrusion of the material from the first extruder at the one or more first locations and the material from the second extruder at the one or more second locations. The material from the first extruder may be different from the material from the second extruder.

In these and other embodiments of the method 400, coordinating extrusion of the material from the first extruder at the one or more first locations on the first plane may include coordinating extrusion of a concrete material from the first extruder at a plurality of first locations. Coordinating extrusion of the material from the second extruder at the one or more second locations on the first plane may include coordinating extrusion of a fiber-reinforced polymer material from the second extruder at the one or more second locations between portions of the plurality of first locations and contacting the first material proximate to at least some of the portions of the plurality of first locations within the predetermined amount of time. In these and other embodiments, the method 400 also may include, with the controller, coordinating extrusion of an insulation material from a third extruder at one or more third locations between the between the portions of the plurality of first locations and contacting one or more of the first material proximate to at least some of the portions of the plurality of first locations or the second material at the one or more second locations within the predetermined amount of time.

In these and other embodiments, the method 400 may further include, with the controller, coordinating extrusion of the concrete material from the first extruder at a plurality of additional first locations on a second plane and at least partially overlapping the plurality of first locations. The method 400 also may include, with the controller, coordinating extrusion of the fiber-reinforced polymer material from the second extruder at the one or more additional second locations on the second plane between portions of the plurality of additional first locations and contacting the first material proximate to at least some of the portions of the plurality of additional first locations within an additional predetermined amount of time of the extrusion of the concrete material at the plurality of additional first locations, the one or more additional second locations at least partially overlapping the one or more second locations. In some embodiments, the method 400 also includes, with the controller, coordinating extrusion of the insulation material from the third extruder at one or more additional third locations on the second plane between the between the portions of the plurality of first locations and contacting one or more of the concrete material proximate to at least some of the portions of the plurality of additional first locations or the fiber-reinforced polymer material at the one or more additional second locations within the additional predetermined amount of time to form a wall including the concrete material, the fiber-reinforced polymer material, and the insulation material. In some embodiments, the controller coordinates the extrusion of the fiber-reinforced material from the second extruder at the one or more additional second locations on top of the one or more second locations and contacting the concrete material proximate to at least a portion of the plurality of additional first locations within the additional predetermined amount of time before the concrete material at the at least a portion of the one or more first additional locations solidifies.

Acts of the method 400 are for illustrative purposes. For example, unless otherwise noted, the acts of the method 400 may be performed in different orders, split into multiple acts, modified, supplemented, or combined.

In some embodiments, a method of forming a structure through additive manufacturing includes moving one or more printing heads of the additive manufacturing system, simultaneously moving a first extruder secured to at least one of the one or more printing heads and a second extruder secured to at least one of the one or more printing heads, extruding material from the first extruder at one or more first locations on a first plane, and extruding material from the second extruder at one or more second locations on the first plane contacting the first material proximate to at least a portion of the one or more first locations within a predetermined amount of time of the extrusion of the material from the first extruder before the material from the first extruder at the at least a portion of the one or more first locations solidifies.

The method also may include simultaneously extruding the material from the first extruder at the one or more first locations and the material from the second extruder at the one or more second locations. The material from the first extruder may be different from the material from the second extruder.

Extruding the material from the first extruder at the one or more first locations on the first plane may include extruding a concrete material from the first extruder at a plurality of first locations. Extruding the material from the second extruder at the one or more second locations on the first plane may include extruding a fiber-reinforced polymer material from the second extruder at the one or more second locations between portions of the plurality of first locations and contacting the first material proximate to at least some of the portions of the plurality of first locations within the predetermined amount of time. The method also may include extruding an insulation material from a third extruder at one or more third locations between the between the portions of the plurality of first locations and contacting one or more of the first material proximate to at least some of the portions of the plurality of first locations or the second material at the one or more second locations within the predetermined amount of time, the third extruder being secured to at least one of the one or more printing heads.

The method also may include extruding the concrete material from the first extruder at a plurality of additional first locations on a second plane and at least partially overlapping the plurality of first locations. The method also may include coordinating extrusion of the fiber-reinforced polymer material from the second extruder at the one or more additional second locations on the second plane between portions of the plurality of additional first locations and contacting the first material proximate to at least some of the portions of the plurality of additional first locations within an additional predetermined amount of time of the extrusion of the concrete material at the plurality of additional first locations, the one or more additional second locations at least partially overlapping the one or more second locations. The method also may include extruding the insulation material from the third extruder at one or more additional third locations on the second plane between the between the portions of the plurality of first locations and contacting one or more of the first material proximate to at least some of the portions of the plurality of additional first locations or the second material at the one or more additional second locations within the additional predetermined amount of time to form a wall including the concrete material, the fiber-reinforced polymer material, and the insulation material.

The fiber-reinforced material from the second extruder may be deposited (e.g., extruded) at the one or more additional second locations on top of the one or more second locations and contacting the first material proximate to at least a portion of the plurality of additional first locations within the additional predetermined amount of time before the concrete material at the at least a portion of the one or more first additional locations solidifies.

As used herein, the terms “about” or “substantially” refer to an allowable variance of the term modified by “about” by ±10% or ±5%. Further, the terms “less than,” “or less,” “greater than,” “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting.

What is claimed is:

1. An additive manufacturing system, comprising:
one or more material sources having one or more materials;
one or more printing heads;
a first extruder secured to at least one of the one or more printing heads and operably coupled to a material source of the one or more material sources, the first extruder configured to selectively deposit a material of the one or more materials from the one or more material sources;
a second extruder secured to at least one of the one or more printing heads and operably coupled to a material source of the one or more material sources, the second extruder configured to selectively deposit a material of the one or more materials from the one or more material sources; and
a controller operably coupled to the one or more printing heads, the first extruder, and the second extruder, the controller configured to coordinate movement of the one or more printing heads, simultaneous movement and independent translation of the first extruder and the second extruder, and deposition of (1) material from the first extruder at one or more first locations and (2) material from the second extruder at one or more second locations with the material from the second extruder contacting at least a portion of the material from first extruder at the one or more first locations within a predetermined amount of time before the material from the first extruder at the at least a portion of the one or more first locations solidifies.

2. The additive manufacturing system of claim 1, wherein the controller is configured to coordinate substantially simultaneous extrusion of the material from the first extruder at the one or more first locations and the material from the second extruder at the one or more second locations.

3. The additive manufacturing system of claim 1, wherein:
the one or more material sources having one or more materials includes a first material source having a first material and a second material source having a second material different from the first material;
the first extruder is operably coupled to the first material source and configured to selectively deposit the first material from the first material source; and
the second extruder is operably coupled to the second material source and configured to selectively deposit the second material from the second material source.

4. The additive manufacturing system of claim 3, wherein:
the first material is a concrete material;
the second material is a metal material; and
the controller is configured to coordinate extrusion of the concrete material from the first extruder at the one or more first locations and deposition of the metal material from the second extruder at the one or more second locations with the concrete material at least partially surrounding an outer periphery of the material.

5. The additive manufacturing system of claim 3, further comprising:
a third material source with a third material including an insulation material;
a third extruder secured to at least one of the one or more printing heads and operably coupled to the third material source, the third extruder configured to selectively deposit the insulation material from the third material source;
wherein the first material includes a concrete material, and the second material includes a reinforcement material; and
wherein the controller is operably coupled to the third extruder and configured to coordinate movement of the one or more printing heads, simultaneous movement of the first extruder, the second extruder, and the third extruder, and extrusion of (1) the concrete material from the first extruder at a plurality of first locations, (2) the reinforcement material from the second extruder at the one or more second locations between portions of the plurality of first locations and contacting the concrete material at some of the portions of the plurality of first locations within the predetermined amount of time, and (3) the insulation material from the third extruder at one or more third locations between the portions of the plurality of first locations and contacting one or more of the concrete material or the reinforcement polymer material at some of the portions of the plurality of first locations or the one or more second locations within the predetermined amount of time.

6. The additive manufacturing system of claim 5, further comprising:
a fourth material source with a drywall material;
a fourth extruder secured to at least one of the one or more printing heads and operably coupled to the fourth material source, the fourth extruder configured to selectively deposit the drywall material; and
wherein the controller is configured to coordinate extrusion of the drywall material at one or more fourth locations adjacent to the one or more first locations with at least some of the concrete material deposited from the first extruder between the drywall material deposited by the fourth extruder and at least some of at least one of the insulation material or the reinforcement material.

7. The additive manufacturing system of claim 1, wherein the one or more first locations and the one or more second locations are on a single first plane.

8. The additive manufacturing system of claim 6, wherein the controller is further configured to coordinate extrusion of (1) the material from the first extruder at one or more additional first locations on a second plane on top of the one or more first locations and (2) the material from the second extruder at one or more additional second locations on the second plane on top of the one or more second locations.

9. The additive manufacturing system of claim 7, wherein the controller is configured to coordinate extrusion of the material from the second extruder at the one or more additional second locations on top of the one or more second locations and contacting at least a portion of the first material at the one or more additional first locations within an additional predetermined amount of time before the first material at the at least a portion of the one or more first additional locations solidifies.

10. An additive manufacturing system, comprising:
one or more material sources having one or more materials;
one or more printing heads;
a first extruder secured to at least one of the one or more printing heads and operably coupled to a material source of the one or more material sources, the first extruder configured to selectively deposit a material of the one or more materials from the one or more material sources;
a second extruder secured to at least one of the one or more printing heads and operably coupled to a material source of the one or more material sources, the second extruder configured to selectively deposit a material of the one or more materials from the one or more material sources; and
a controller operably coupled to the one or more printing heads, the first extruder, and the second extruder, the controller configured to coordinate:
movement of the one or more printing heads;
simultaneous movement and independent translation of the first extruder and the second extruder;
extrusion of material of the one or more materials from the first extruder at one or more first locations on a first plane;
extrusion or deposition of material of the one or more materials from the second extruder at one or more second locations on the first plane within a predetermined amount of time from the extrusion of the material from the first extruder on the first plane;
extrusion of material of the one or more materials from the first extruder at one or more additional first locations on a second plane and at least partially overlapping the one or more first locations before at least some of the material from the first extruder on the first plane has solidified; and
extrusion or deposition of material of the one or more materials from the second extruder at one or more additional second locations on the second plane and at least partially overlapping the one or more second locations before at least some of the material from the second extruder on the first plane has solidified.

11. The additive manufacturing system of claim 10, wherein the controller is configured to coordinate substantially simultaneous extrusion of material of the one or more materials from the first extruder at the one or more first locations and material of the one or more materials from the second extruder at the one or more second locations.

12. The additive manufacturing system of claim 10, wherein:
the one or more material sources having one or more materials includes a first material source having a first material and a second material source having a second material different from the first material;
the first extruder is operably coupled to the first material source and configured to selectively deposit the first material from the first material source;
the second extruder is operably coupled to the second material source and configured to selectively deposit the second material from the second material source; and
the controller is configured to coordinate extrusion of the first material from the first extruder at the one or more first locations on the first plane, extrusion of the second material from the second extruder at the one or more second locations on the first plane within the predetermined amount of time from the extrusion of the first material on the first plane, extrusion of the first material from the first extruder at the one or more additional first locations on the second plane and at least partially overlapping the one or more first locations before the first material on the first plane has solidified, and extrusion of the second material from the second extruder at the one or more additional second locations on the second plane and at least partially overlapping the one or more second locations before the second material on the second plane has solidified.

13. The additive manufacturing system of claim 12, wherein:
the first material is a concrete material;
the second material is a metal material; and
the controller is configured to coordinate extrusion of the concrete material from the first extruder at the one or more first locations and deposition of the metal material from the second extruder at the one or more second locations with the concrete material at least partially surrounding an outer periphery of the material.

14. The additive manufacturing system of claim 12, further comprising:
a third material source with a third material including an insulation material;
a third extruder secured to at least one of the one or more printing heads and operably coupled to the third material source, the third extruder configured to selectively deposit the insulation material from the third material source;
wherein the first material includes a concrete material, and the second material includes a reinforcement material; and
wherein the controller is operably coupled to the third extruder and configured to coordinate movement of the one or more printing heads, simultaneous movement of the first extruder, the second extruder, and the third extruder, and extrusion of (1) the concrete material from the first extruder at a plurality of first locations, (2) the reinforcement material from the second extruder at the one or more second locations between portions of the plurality of first locations and contacting the first material at some of the portions of the plurality of first locations within the predetermined amount of time, and (3) the insulation material from the third extruder at one or more third locations between the portions of the plurality of first locations and contacting one or more of the first material proximate to at least some of the portions of the plurality of first locations or the second material at the one or more second locations within the predetermined amount of time.

15. The additive manufacturing system of claim 14, further comprising:
a fourth material source with a drywall material;
a fourth extruder secured to at least one of the one or more printing heads and operably coupled to the fourth material source, the fourth extruder configured to selectively deposit the drywall material; and
wherein the controller is configured to coordinate extrusion of the drywall material at one or more fourth locations adjacent to the one or more first locations with at least some of the concrete material deposited from the first extruder between the drywall material deposited by the fourth extruder and at least some of at least one of the insulation material or the reinforcement material.

16. A method of additive manufacturing, the method comprising:
with a controller, coordinating movement of one or more printing heads of an additive manufacturing system;
with the controller, coordinating simultaneous movement and independent translation of a first extruder secured to at least one of the one or more printing heads and a second extruder secured to at least one of the one or more printing heads;
with the controller, coordinating extrusion of material from the first extruder at one or more first locations on a first plane; and
with the controller, coordinating extrusion or deposition of material from the second extruder at one or more second locations on the first plane contacting the first material proximate to at least a portion of the one or more first locations within a predetermined amount of time of the extrusion of the material from the first extruder before the material from the first extruder at the at least a portion of the one or more first locations solidifies.

17. The method of claim 16, wherein the controller coordinates substantially simultaneous extrusion of the material from the first extruder at the one or more first locations and the material from the second extruder at the one or more second locations.

18. The method of claim 16, wherein the material from the first extruder is different from the material from the second extruder.

19. The method of claim 18, wherein:
wherein the first material is a concrete material;
wherein the second material is a metal material; and
with the controller, coordinating extrusion or deposition of material from the second extruder includes with the controller, coordinating deposition of the metal material at one or more second locations on the first plane contacting the concrete material with the concrete material at least partially surrounding an outer periphery of the metal material.

20. The method of claim 18, further comprising:
wherein coordinating extrusion of the material from the first extruder at the one or more first locations on the first plane includes coordinating extrusion of a concrete material from the first extruder at a plurality of first locations;
wherein coordinating extrusion of the material from the second extruder at the one or more second locations on the first plane includes coordinating extrusion of a reinforcement material from the second extruder at the one or more second locations between portions of the plurality of first locations and contacting the concrete material proximate to at least some of the portions of the plurality of first locations within the predetermined amount of time; and
with the controller, coordinating extrusion of an insulation material from a third extruder at one or more third locations between the between the portions of the plurality of first locations and contacting one or more of the concrete material proximate to at least some of the portions of the plurality of first locations or the one or more second locations within the predetermined amount of time, the third extruder being secured to at least one of the one or more printing heads.

21. The method of claim 20, further comprising:
with the controller, coordinating extrusion of the concrete material from the first extruder at a plurality of additional first locations on a second plane and at least partially overlapping the plurality of first locations;
with the controller, coordinating extrusion of the reinforcement material from the second extruder at the one or more additional second locations on the second plane between portions of the plurality of additional first locations and contacting the first material proximate to at least some of the portions of the plurality of additional first locations within an additional predetermined amount of time of the extrusion of the concrete material at the plurality of additional first locations, the one or more additional second locations at least partially overlapping the one or more second locations; and
with the controller, coordinating extrusion of the insulation material from the third extruder at one or more additional third locations on the second plane between the between the portions of the plurality of first locations and contacting one or more of the concrete material proximate to at least some of the portions of the plurality of additional first locations or the reinforcement material at one or more additional second locations within the additional predetermined amount of time to form a wall including the concrete material, the reinforcement material, and the insulation material.

22. The method of claim 20, wherein the controller coordinates the extrusion of the reinforcement material from the second extruder at the one or more additional second locations on top of the one or more second locations and contacting the concrete material proximate to at least a portion of the plurality of additional first locations within the additional predetermined amount of time before the concrete material at the at least a portion of the one or more first additional locations solidifies.
